(19) United States
(12) Patent Application Publication
(10) Pub. No.: US 2007/0106563 A1
(43) Pub. Date: May 10, 2007

(54) Apparatus and method for managing data of rental contracts

(75) Inventors: Kazuo Okada, Tokyo (JP); Jun Fujimoto, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 11/496,469

(22) Filed: Aug. 1, 2006

(30) Foreign Application Priority Data
Aug. 8, 2005 (JP) JP2005-229357

(51) Int. Cl. G06Q 30/00

(52) U.S. Cl. 705/26

(57) ABSTRACT

There are disclosed an apparatus and a method for managing data of rental contracts with a plurality of customers. The apparatus is provided with a storage, an input device, and a controller. The storage stores a plurality of contract data, each of which includes a customer ID, item IDs, numbers of items to be applied to rental contracts, a data table of discount rates, dates of the rental contracts, and terms of the rental contracts. The input device receives input of new data, each of which includes a new customer ID, new item IDs, new numbers of items to be applied to new rental contracts, application dates of the new rental contracts, and new terms of the new rental contracts. The controller reads out and sums up the numbers of the items.

### CROSS-REFERENCE TO RELATED APPLICATIONS

This application is based upon and claims the benefit of priority from the prior Japanese Patent Application No. 2005-229357 (filed Aug. 8, 2005); the entire contents of which are incorporated herein by reference.

### BACKGROUND OF THE INVENTION

1. Field of the Invention

The present invention relates to an apparatus and a method for managing data of rental contracts to controllably determine discount rates on the basis of occasional circumstances.

2. Description of the Related Art

Built-in machines equipped in shops, halls or arcades, such as gaming machines in gaming arcades, could be dealt with in either transaction type of purchase or rental. Owners of gaming arcades may have a motivation to select rental contractions. One of the reasons may be that their visitors are mutable in their preference and they need to flexibly change machines in accordance with the change of visitors' preference. Another may be that they require to control risky investment accompanying purchase.

For vendors, rental contracts give rise to bothersome tasks for managing data thereof, which differ among respective customer sand depend on time and circumstances. Discount rates of fees may either rise or fall in accordance with occasional circumstances, such as past records of transactions with the customers, contraction dates, numbers of items, and terms for rental.

### SUMMARY OF THE INVENTION

An object of the present invention is providing an apparatus and a method for managing data of rental contracts to controllably determine discount rates on the basis of occasional circumstances.

According to a first aspect of the present invention, an apparatus for managing data of rental contracts with a plurality of customers is provided with a storage storing a plurality of contract data, each contract datum including a customer ID identifying a customer, one or more item IDs identifying items, one or more numbers of items to be applied to rental contracts, a data table of discount rates, one or more dates of the rental contracts, and one or more terms of the rental contracts, the customer ID, the item IDs, the numbers, the dates, and the terms being interrelated in each rental contract; an input device receiving input of new data, each new datum including a new customer ID, one or more new item IDs, one or more new numbers of items to be applied to new rental contracts, one or more application dates of the new rental contracts, and one or more new terms of the new rental contracts; and a controller reading out and summing up the numbers included in the contract data correspondent to the new customer ID and effective on the application date, from the storage and adding the new numbers of the new rental contracts to the numbers being summed-up to calculate and display a total number of items.

Preferably, the controller determines a discount rate correspondent to the total number by referring to the data table of the discount rates.

More preferably, the storage further stores a price data table of unit prices respectively determined for the items and the controller calculates and displays a total rental fee based on the discount rate, the total number and the price data table.

Still preferably, the controller calculates and displays a combination of total numbers of items respectively for every combinations of contract data regarding all contracts effective on the application dates and the new data regarding the new applications.

Further still preferably, the controller determines discount rates respectively for all the total numbers by referring the data table of discount rates.

More preferably, the storage further stores a price data table of unit prices respectively determined for the items and the controller calculates and displays a combination of total rental fees based on the discount rates, the combination of the total numbers and the price data table.

According to a second aspect of the present invention, a method for managing data of rental contracts with a plurality of customers is provided with: storing a plurality of contract data in a storage, each contract datum including a customer ID identifying a customer, one or more item IDs identifying items, one or more numbers of items to be applied to rental contracts, a data table of discount rates, one or more dates of the rental contracts, and one or more terms of the rental contracts, the customer ID, the item IDs, the numbers, the dates, and the terms being interrelated in each rental contract; receiving input of new data via an input device, the new data including a new customer ID, one or more new item IDs, one or more new numbers of items to be applied to new rental contracts, one or more application dates of the new rental contracts, one or more new terms of the new rental contracts; reading out and summing up the numbers included in the contract data correspondent to the new customer ID and effective on the application date, from the storage; calculating a total number of items by adding the new numbers of the new rental contracts to the numbers being summed-up; and displaying the total number on a display.

Preferably, the method is further provided with: determining a discount rate correspondent to the total number by referring to the data table of the discount rates.

More preferably, the method is further provided with: storing a price data table of unit prices respectively determined for the items; calculating a total rental fee based on the discount rate, the total number and the price data table; and displaying the total rental fee on the display.

Still preferably, the method is further provided with: calculating a combination of total numbers of items respectively for every combinations of contract data regarding all contracts effective on the application dates and the new data regarding the new applications; and displaying the combination of the total numbers of items on the display.

Further still preferably, the method is further provided with determining discount rates respectively for all the total numbers by referring the data table of discount rates.

More preferably, the method is further provided with: storing a price data table of unit prices respectively determined for the items in the storage; calculating a combination of total rental fees based on the discount rates, the combination of the total numbers and the price data table; and displaying the combination of the total rental fees on the display.

According to a third aspect of the present invention, a computer readable medium storing a program for operation of a computer is provided with: a storing routine storing a plurality of contract data in a storage, each contract datum including a customer ID identifying a customer, one or more item IDs identifying items, one or more numbers of items to be applied to rental contracts, a data table of discount rates, one or more dates of the rental contracts, and one or more terms of the rental contracts, the customer ID, the item IDs, the numbers, the dates, and the terms being interrelated in each rental contract; an input routine receiving input of new data via an input device, the new data including a new customer ID, one or more new item IDs, one or more new numbers of items to be applied to new rental contracts, one or more application dates of the new rental contracts, one or more new terms of the new rental contracts; a summing routine reading out and summing up the numbers included in the contract data correspondent to the new customer ID and effective on the application date, from the storage; a calculation routine calculating a total number of items by adding the new numbers of the new rental contracts to the numbers being summed-up; and a display routine displaying the total number on a display.

### BRIEF DESCRIPTION OF THE DRAWINGS

FIG. 1 is a block diagram of a computer applied to an apparatus for managing data of rental contracts in accordance with an embodiment of the present invention;

FIG. 2 is a block diagram of a computer system including interactions among a server and respective terminals in accordance with another embodiment;

FIG. 3 is a block diagram of a computer for the server;

FIG. 4 is a block diagram of a data processing system for any of the terminal;

FIG. 5 is a flowchart illustrating a part of calculation executed in the apparatus in accordance with one version of the invention;

FIG. 6 illustrates an entry screen for inputting new contract data;

FIG. 7 illustrates a result screen for calculation of a total number of rental items;

FIG. 8 is a flowchart illustrating a part of calculation executed in the apparatus in accordance with one version of the invention;

FIG. 9 illustrates a result screen for a determined discount rate;

FIG. 10 is a flowchart illustrating a part of calculation executed in the apparatus in accordance with another version of the invention;

FIG. 11 is an example of a result screen for calculation of a total rental fee;

FIG. 12 is an example of a data table of contract data;

FIG. 13 is an example of a data table of discount rates;

FIG. 14 is an example of a data table of rental fee unit price;

FIG. 15 illustrates a result screen for calculation of a total number of rental items;

FIG. 16 illustrates a result screen for determined discount rate; and

FIG. 17 illustrates a result screen for calculation of a total rental fee.

### DETAILED DESCRIPTION OF THE INVENTION

An embodiment of the present invention will be described hereinafter with reference to the drawings.

—General Constitution—

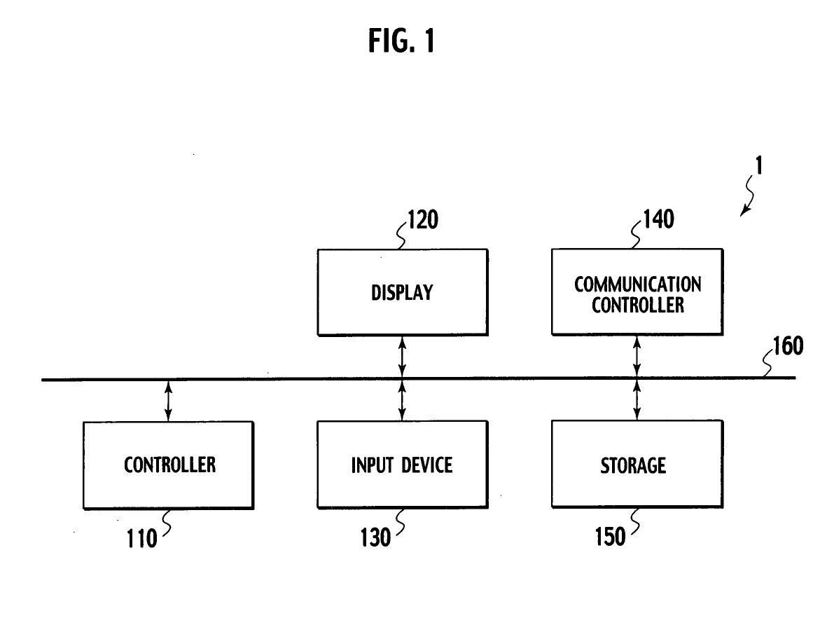

Referring to FIG. 1, a computer 1 applied to an apparatus for managing data of rental contracts in accordance with the present embodiment is provided with a controller 110, a display 120, an input device 130, a communication controller 140, and a storage 150, all of which are interlinked via a bus 160.

Mobile data processing devices, such as mobile phones, PDAs and electronic organizers, may be applied to the apparatus in accordance with the present embodiment.

The controller 110 is configured to process and/or calculate various data and may be, but not limited to, a so-called CPU (Central Processing Unit). The controller 110 controls the whole of the computer 1, and reads and writes programs and data stored in the storage 150 to execute the programs for serving various functions in cooperation with the above hardware equipments.

The display 120 is configured to display images for invitation of users to input data and for informing calculation results and may include, but not limited to, any of a CRT (cathode ray tube) or a LCD (liquid crystal display).

The input device 130 is configured to receive inputs by users and may include, but not limited to, a keyboard, a pointing device or such. The input device 130 is linked to the computer 1 directly or with intervening an input/output (I/O) facility.

The communication controller 140 is a network adapter configured to link the computer 1 with external data processing systems or storages via a private network or a public network. Any of a modem, a cable modem and an Ethernet (registered trademark) adapter may be included in the communication controller 140.

The storage 150 is a computer readable medium and may include a local memory for executing programs in cooperation with the controller 110, a bulk memory for storing a large quantity of data, and a cache memory of help to access to the bulk memory with reduced latency. Any means, such as electric, magnetic, optical or electromagnetic means, may be applied to memory modules for the storage 150. As concrete examples, a semiconductor memory, a magnetic tape, a flexible disk, a random access memory (RAM), a read only memory (ROM), optical disks, such as a CD-ROM, a CD-R/W or a DVD, may be exemplified.

—General Constitution in Another Embodiment—

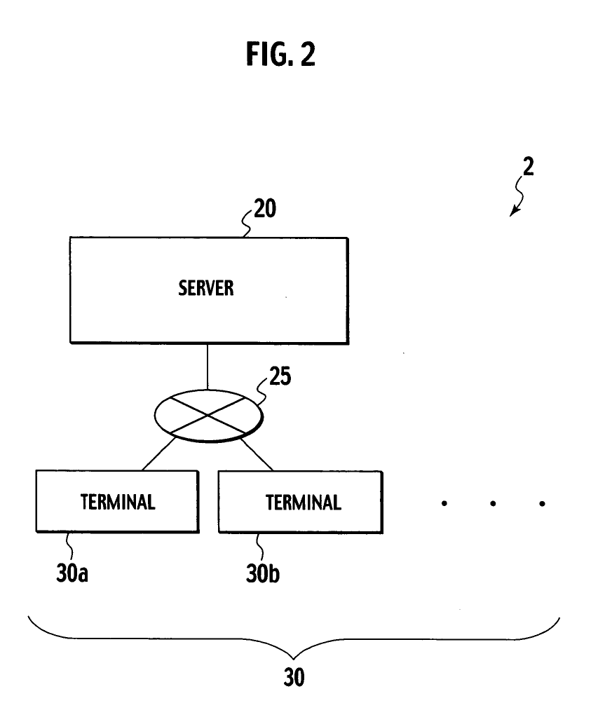

Referring to FIG. 2, a computer system 2 applied to an apparatus for managing data of rental contracts in accordance with the present embodiment is provided with a server 20 and a plurality of terminals 30a, 30b, . . . (or a group of terminals 30), all of which are interlinked via a communication network 25.

—Details of the SERVER—

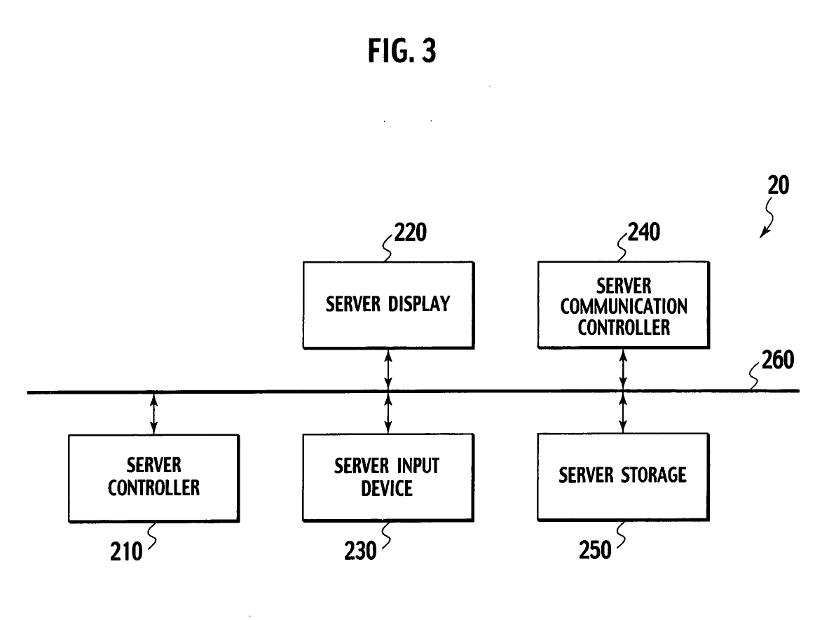

Referring to FIG. 3, the server 20 is provided with a server controller 210, a server display 220, a server input device 230, a server communication controller 240, and a server storage 250, all of which are interlinked via a bus (a server bus) 260.

The server controller 210 is constituted as similar to the aforementioned controller 110, controls the whole of the server 20, reads and writes programs and data stored in the server storage 250 to execute the programs for serving various functions in cooperation with the above hardware equipments.

The server display 220, the server input device 230, the server communication controller 240, and the server storage 250 are also constituted as respectively similar to the display 120, the input device 130, the communication controller 140, and the storage 150 as described above.

—Details of the TERMINAL—

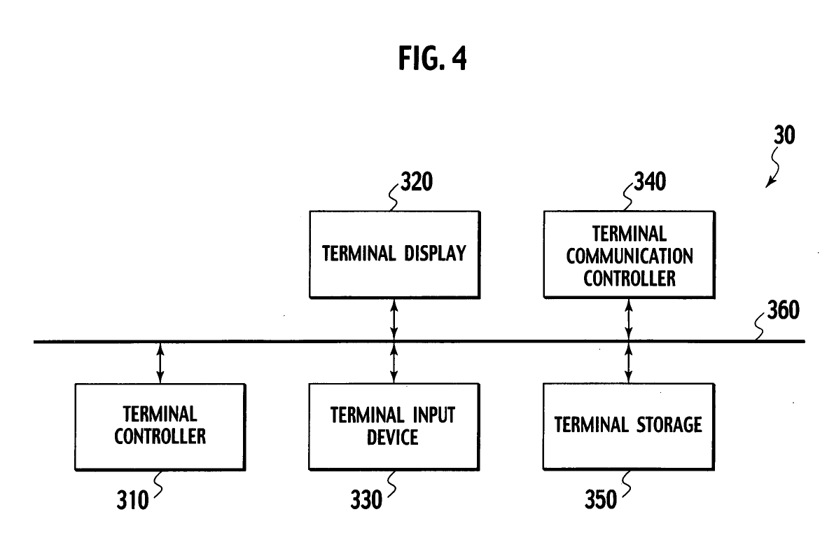

Referring to FIG. 4, each of the terminals 30 is provided with a terminal controller 310, a terminal display 320, a terminal input device 330, a terminal communication controller 340, and a terminal storage 350, all of which are interlinked via a bus (a terminal bus) 360.

The terminal controller 310 is constituted as similar to the aforementioned controller 110, controls the whole of the terminal 30, reads and writes programs and data stored in the terminal storage 350 to execute the programs for serving various functions in cooperation with the above hardware equipments.

The terminal display 320, the terminal input device 330, the terminal communication controller 340, and the terminal storage 350 are also constituted as respectively similar to the display 120, the input device 130, the communication controller 140, and the storage 150 as described above.

—Details of the COMMUNICATION NETWORK—

Examples of the communication network 25 include, but are not limited to, wire networks, such as a network on private lines, a dial-up network via modems or terminal adapters, an ADSL (Asymmetric Digital Subscriber Line) on telephone lines, and any networks on optical cables, and wireless networks, such as a wireless LAN and a wireless mobile network for mobile phones.

Various communication protocol, such as a TCP/IP, which is widely used in the Internet, are applicable to the communication network 25 to establish communications thereon. Further, a protocol referred to as SOAP (Simple Object Access Protocol), which is widely used for Web services, is also applicable thereto.

The computer system 2 serves as the apparatus for managing data of rental contracts by means of the server 20 and the terminals 30 interlinked via the communication network 25.

While FIG. 3 includes only one server, two or more servers may be included in the apparatus. Moreover, the apparatus may be constituted as a server system having a so-called three-layer structure, which is composed of three layers of a Web server, an application server, and a database server. A constitution of the server system may be preferably selected in view of load to the system, a data capacity, or any consideration for operation.

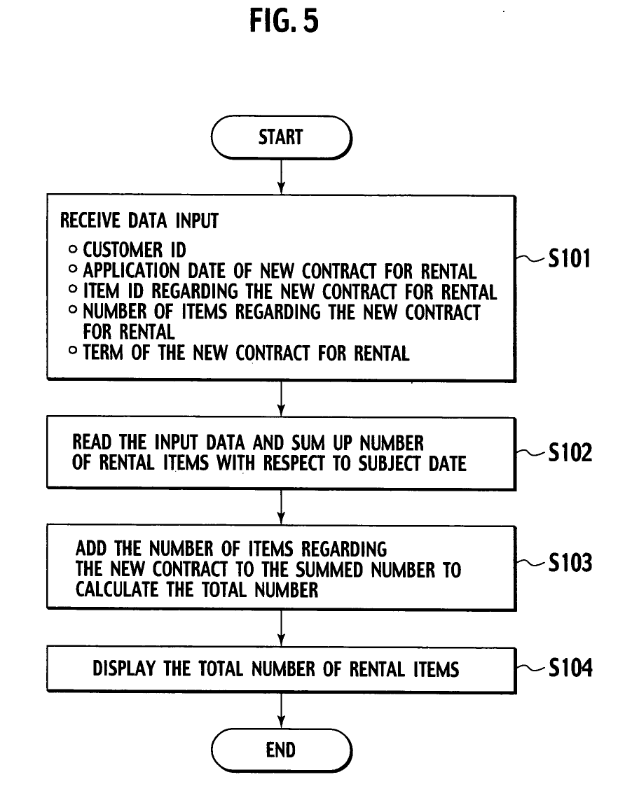

Operations implemented by the present apparatus will be described hereinafter with reference to FIGS. 5 through 17. Referring to FIG. 5, the controller 110 receives inputs of data from the input device 130, where each data includes a customer ID, an application date of a new contract for rental, an item ID regarding the new contract for rental, a number of items regarding the new contract for rental, and a term of the new contract for rental, and stores the data in the storage 150 (step S101).

In the instant example, merely one contract is received in one set of input, however, it may be modified so that two or more contracts are received in one set of input.

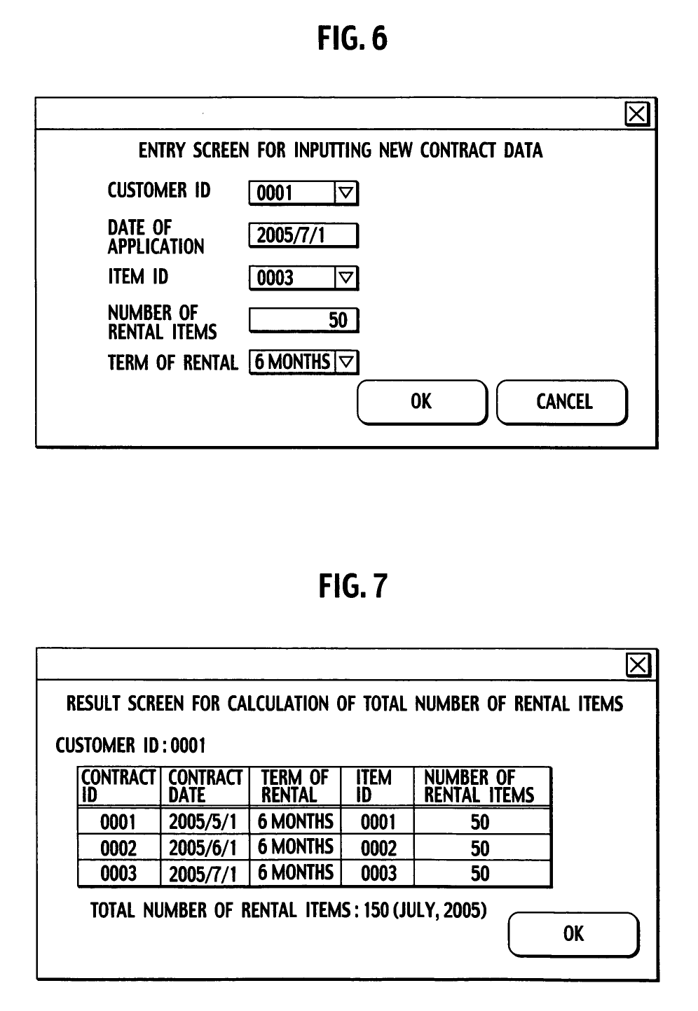

FIG. 6 shows an example of an entry screen at a time of inputting new contract data into the apparatus of the embodiment. As in this example, a user inputs “0001” as a customer ID, “2005/7/1” as an application date of a new contract for rental, “0003” as an item ID regarding the new contract for rental, “50” as a number of items regarding the new contract for rental, and “six months” as a term of the new contract for rental, via the input device 130, and presses down the “OK” button. Then the apparatus starts calculation of a discount rate with respect to the customer identified by the customer ID “0001”.

If the apparatus is modified to receive a plurality of contracts at once, the entry screen may have a plurality of input boxes, be arranged in a table form, or be designed in a so-called shopping cart style.

Next, based on the received data of the customer ID and the application date, the controller 110 reads out and sums up the number of rental items in the input data of the instant customer, which is effective on the application date, from the storage 150 (step S102).

Next, the controller 110 adds the number of rental items with regarding the new contract to the summed-up number of rental items to calculate a total number of rental items (step S103).

Next, the controller 110 displays the total number of rental items on the display 120 (step S104).

FIG. 7 shows an example of a result screen for calculation of the total number of rental items. As in this example, the result screen shows “150” as the total number of items on “2005/7” for the customer ID “0001”.

By such a screen, the customer or a dealer of the vendor may be easily informed of a data of a discount rate correspondent to the total number of rental items by referring to a price list or such.

In the instant example, the screen shows the data regarding merely one month of July 2005, however, it may be modified so that a plurality of data of each and every months until the correspondent rental contract end may be displayed (not shown). For example, the result screen may show “100” as the total number of items on “2005/11” and “50” on “2005/12” at once.

Further, the screen shows the total number of items effective on the application date of the new contract for rental regardless of distinction of the item ID, however, it may be modified so that the total numbers may be displayed with respect to the respective item IDs.

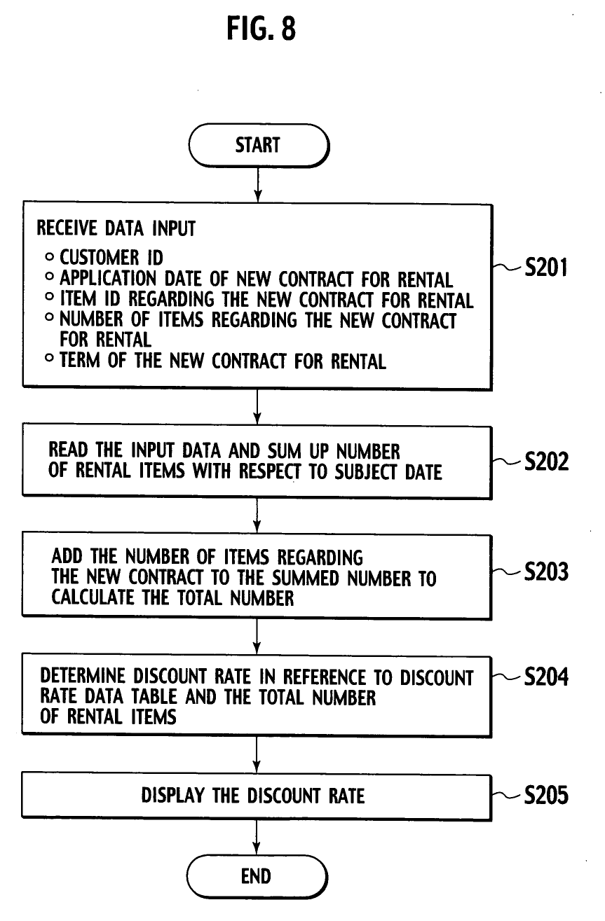

Referring to FIG. 8, the controller 110 receives inputs of data from the input device 130, where each data includes a customer ID, an application date of a new contract for rental, an item ID regarding the new contract for rental, a number of items regarding the new contract for rental, and a term of the new contract for rental, and stores the data in the storage 150 (step S201), as similar to the aforementioned step S101 shown in FIG. 5.

The controller 110 further executes steps S202 and S203 as similar to the aforementioned steps S102 and S103 to calculate the total number of rental items.

Next, the controller 110 refers to a data table of discount rates stored in the storage 150 to determine a discount rate on the basis of the total number of rental items (step S204).

Next, the controller 110 displays the determined discount rate on the display 120 (step S205).

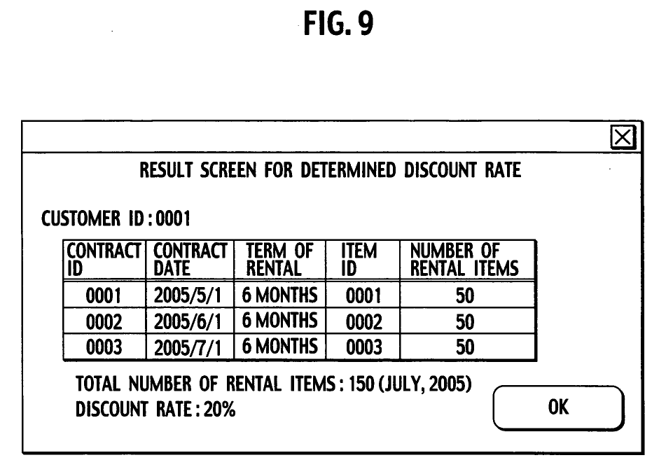

FIG. 9 shows an example of a result screen for a determined discount rate. As in this example, the result screen shows “150” as the total number of items and “20%” as the discount rate on “2005/7” for the customer ID “0001”.

By such a screen on the display 120, the customer or a dealer of the vendor may be easily informed of a data of the discount rate without referring to a price list or such.

In the instant example, the screen shows the data regarding merely one month of July 2005, however, it may be modified so that a plurality of data of each and every months until the correspondent rental contract end may be displayed (not shown). For example, the result screen may show “100” as the total number of items and “10%” as the discount rate on “2005/11” and “50” as the total number of items and “0%” as the discount rate on “2005/12”.

The data table of discount rates may be individually applied to the total numbers summed up with respect to each and every item IDs. In this example, all the discount rates may be 0%.

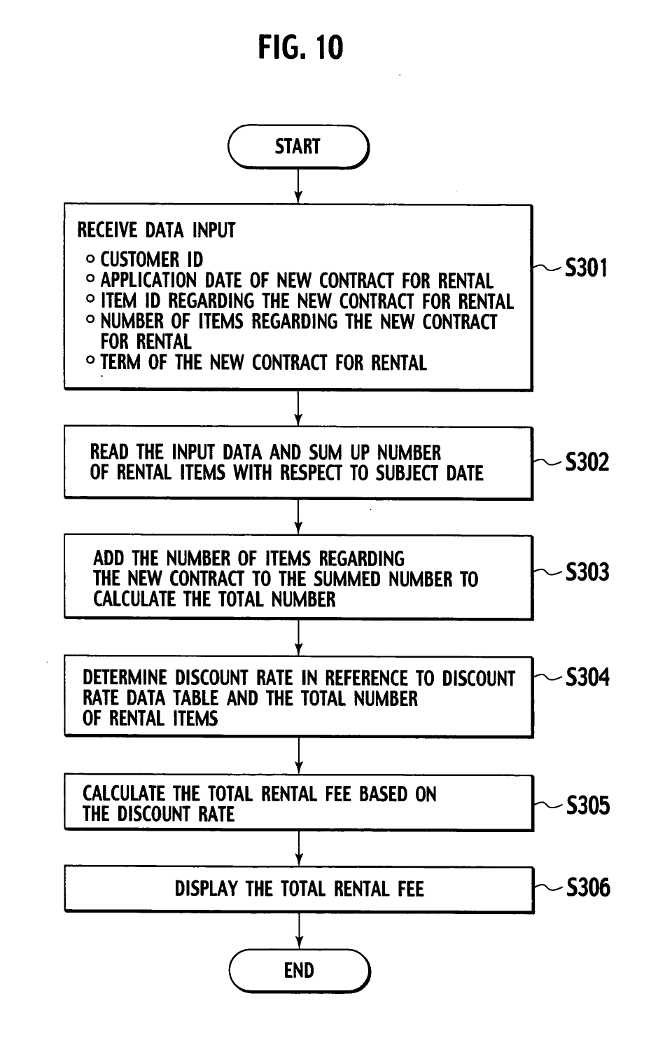

Referring to FIG. 10, the controller 110 receives inputs of data from the input device 130, where each data includes a customer ID, an application date of a new contract for rental, an item ID regarding the new contract for rental, a number of items regarding the new contract for rental, and a term of the new contract for rental, and stores the data in the storage 150 (step S301), as similar to the aforementioned step S101 shown in FIG. 5.

The controller 110 further executes steps S302 through S304 in a way similar to the aforementioned steps to determine the discount rate by referring to the data table of discount rates on the basis of the total number of rental items.

Next, the controller 110 calculates a total rental fee based on the correspondent discount rate (step S305).

Next, the controller 110 displays the total rental fee on the display 120 (step S306).

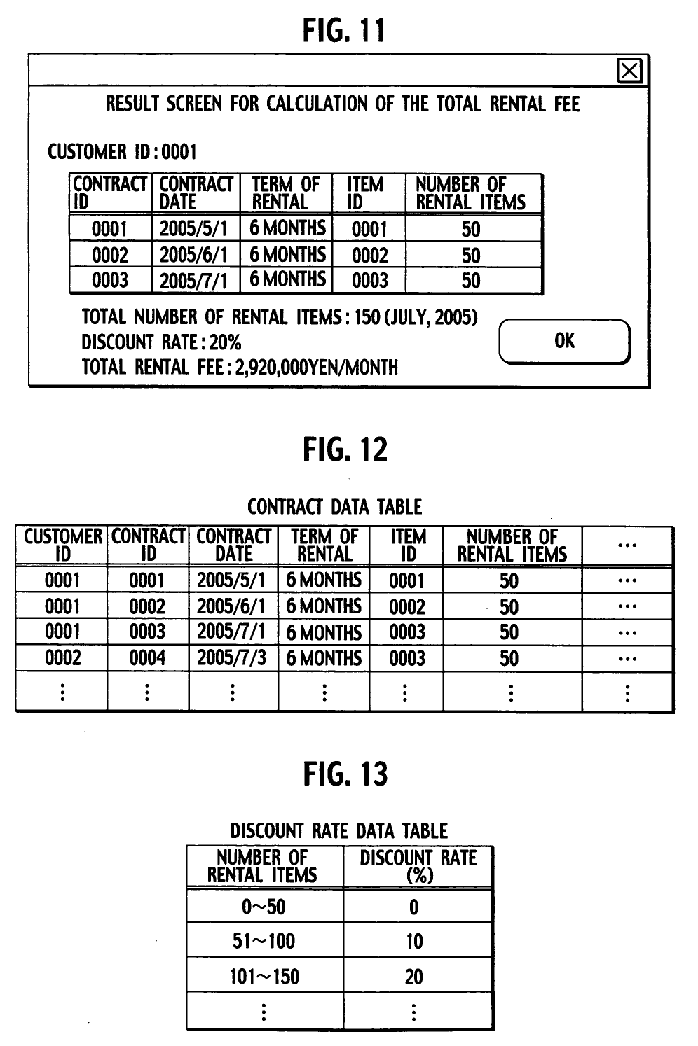

FIG. 11 shows an example of a result screen for calculation of the total rental fee. As in this example, the results screen shows “150” as the total number of items, “20%” as the discount rate, and “2,920,000 yen/month” as the total rental fee on “2005/7” for the customer ID “0001”.

In the instant example, the screen shows the data regarding merely one month of July 2005, however, it may be modified so that a plurality of data of each and every months until the correspondent rental contract end may be displayed (not shown). For example, the result screen may show “100” as the total number of items, “10%” as the discount rate, and “2,160,000 yen” as the total rental fee on “2005/11” and “50” as the total number of items, “0%” as the discount rate, and “2,385,000 yen” as the total rental fee on “2005/12”.

Thereby, at a time of an application of a new rental contract, the customer or a dealer of the vendor may be easily informed of a data of the total rental fee by the screen.

FIG. 12 shows an example of a data table of contract data to be applied to the apparatus in accordance with the present embodiment. In this example, one contract data includes “0001” as a customer ID, “0001” as a contract ID, “2005/5/1” as a contract date, “six months” as a term of the contract for rental, “0001” as an item ID, “50” as a number of items.

FIG. 13 shows an example of a data table of discount rates to be applied to the apparatus in accordance with the present embodiment. In this example, one data of discount defines a discount rate to be “0%” in a case where a number of rental items is from 0 to 50, further, “10%” when a number of rental items is from 51 to 100.

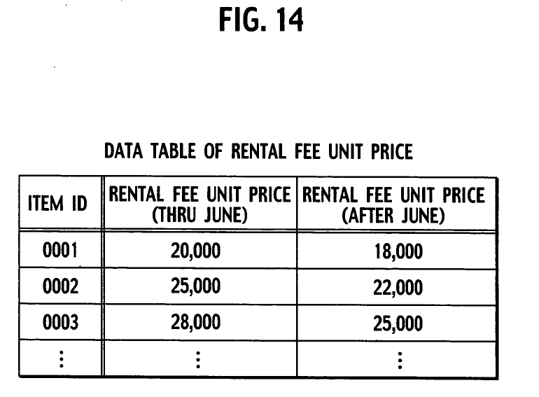

FIG. 14 shows an example of a data table of rental fee unit prices to be applied to the apparatus in accordance with the present embodiment. In this example, one data defines a rental fee unit price with respect to an item identified by the ID “0001” to be “20,000 yen” in a case where a term for rental is within six months, further, “18,000 yen” when a term for rental is over six months.

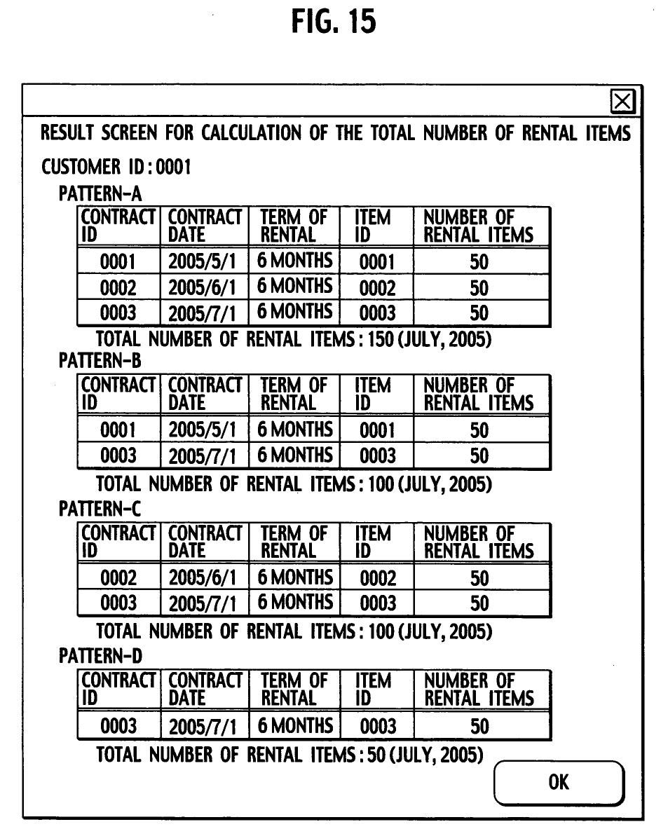

FIG. 15 shows an example of a result screen, as another example of the result screen of FIG. 7, for calculation of a total number of rental items, in which total numbers of rental items are respectively calculated for every combinations of data of numbers of rental items regarding all contracts effective on application dates of new applications for rental and data of numbers of rental items regarding new applications for rental, and then displayed. As in this example, the result screen shows “150” for an A pattern, “100” for a B pattern, “100” for a C pattern, and “50” for a D pattern, respectively as the total number of items, where the A pattern includes contract IDs of 0001, 0002 and 0003, the B pattern 0001 and 0003, the C pattern 0002 and 0003, and the D pattern only 0003.

The above calculations are executed by a combination of the above steps of S103 shown in FIG. 5, and S203 shown in FIG. 8 or S303 shown in FIG. 10. The display of the screen shown in FIG. 15 is executed by the above step S104 shown in FIG. 5.

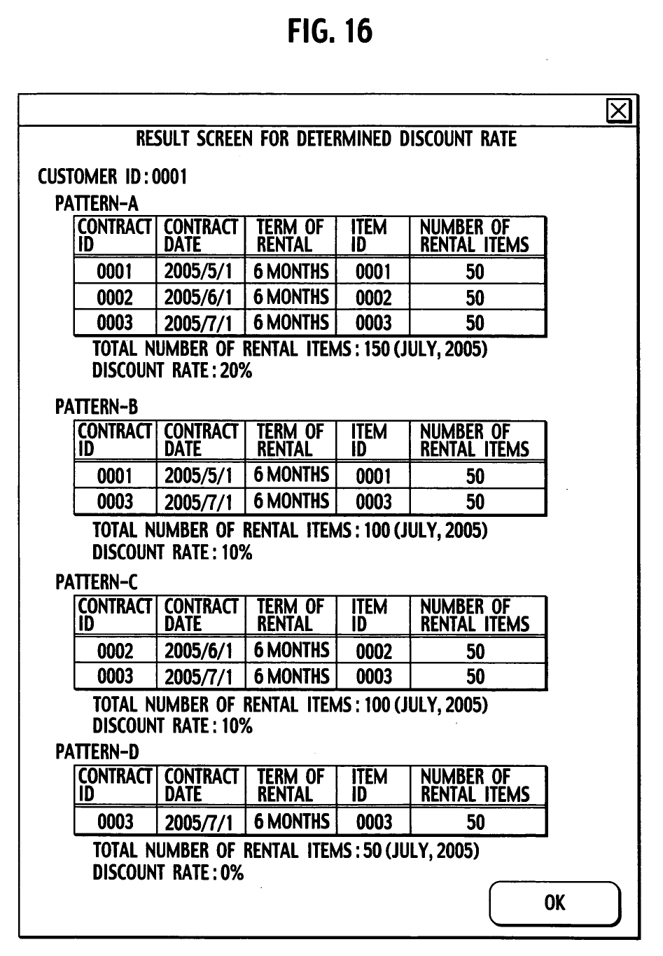

FIG. 16 shows an example of a result screen, as another example of the result screen of FIG. 9, for determination of discount rates, in which discount rates are respectively determined for every total numbers of rental items respectively calculated in accordance with the aforementioned way of the example shown in FIG. 15, and then displayed. As in this example, the result screen shows “20%” as a discount rate for an A pattern, “10%” for a B pattern, “10%” for a C pattern, and “0%” for a D pattern, respectively as the total number of items, where the A pattern includes contract IDs of 0001, 0002 and 0003, the B pattern 0001 and 0003, the C pattern 0002 and 0003, and the D pattern only 0003.

The above determinations of the discount rates are executed by a combination of the above steps of S204 shown in FIG. 8, and S304 shown in FIG. 10. The display of the screen shown in FIG. 16 is executed by the above step S205 shown in FIG. 8.

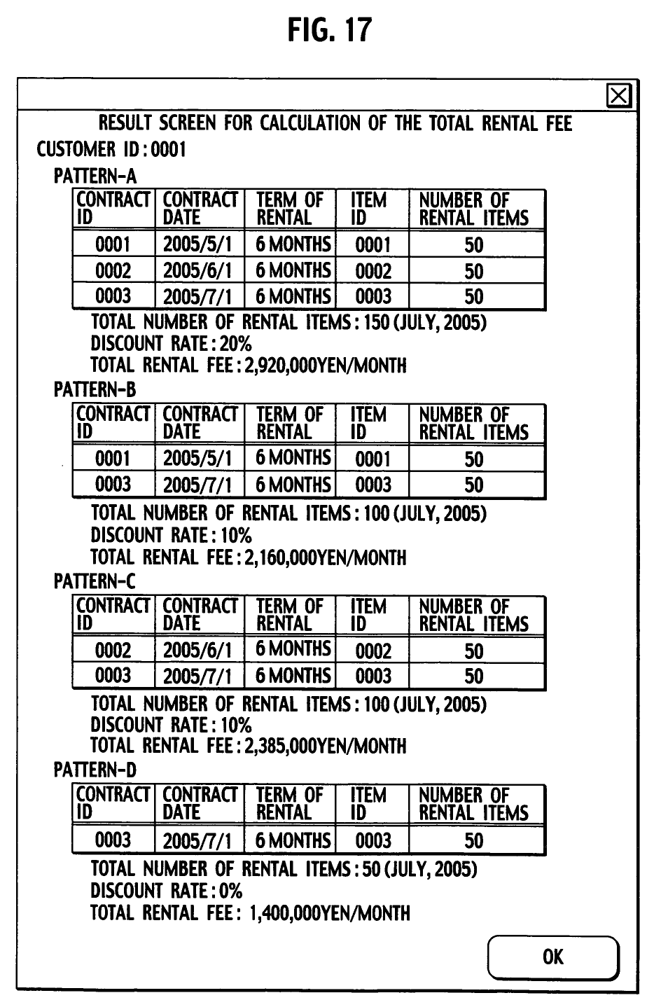

FIG. 17 shows an example of a result screen, as another example of the result screen of FIG. 11, for calculation of the total rental fee, in which total rental fees are respectively calculated for every discount rates respectively determined in accordance with the aforementioned way of the example shown in FIG. 16, and then displayed. As in this example, the result screen shows “2,920,000 yen” as a discount rate for an A pattern, “2,160,000 yen”for a B pattern, “2,385,000 yen”for a C pattern, and “1,400,000 yen” for a D pattern, respectively as the total number of items, where the A pattern includes contract IDs of 0001, 0002 and 0003, the B pattern 0001 and 0003, the C pattern 0002 and 0003, and the D pattern only 0003.

The above calculations of the total rental fees are executed by the above step S305 shown in FIG. 10. The display of the screen shown in FIG. 17 is executed by the above step S306 shown in FIG. 10.

The above embodiment may be appropriately modified. For example, though the discount rate is set to be 20% in FIG. 9, the discount rate of 20% may be applied to the calculation of rental fee by making the number of rental items with respect to the contracts identified by the contract ID 0001 and the contract ID 0002 be subject to summing up for the total number of rental items only when contracts are changed so that the expiration dates of the terms of the contracts identified by the contract ID 0001 and the contract ID 0002 are identical with the expiration date of the term of the new contract identified by the contract ID 0003 regarding the new application for rental (more specifically, the term regarding the contract ID 0001 is changed to be eight months and the term regarding the contract ID 0002 is changed to be seven months), and otherwise these numbers of rental items are not made to be subject to summing up for the total number of rental items.

Although the invention has been described above by reference to certain embodiments of the invention, the invention is not limited to the embodiments described above. Modifications and variations of the embodiments described above will occur to those skilled in the art, in light of the above teachings.

What is claimed is:

1. An apparatus for managing data of rental contracts with a plurality of customers, the apparatus comprising:
a storage storing a plurality of contract data, each contract datum including a customer ID identifying a customer, one or more item IDs identifying items, one or more numbers of items to be applied to rental contracts, a data table of discount rates respectively determined depending on the number, one or more dates of the rental contracts, and one or more terms of the rental contracts, the customer ID, the item IDs, the numbers, the dates, and the terms being interrelated in each rental contract;
an input device receiving input of new data, each new datum including a new customer ID, one or more new item IDs, one or more new numbers of items to be applied to new rental contracts, one or more application dates of the new rental contracts, and one or more new terms of the new rental contracts; and
a controller reading out and summing up the numbers included in the contract data correspondent to the new customer ID and effective on the application date, from the storage and adding the new numbers of the new rental contracts to the numbers being summed-up to calculate and display a total number of items.

2. The apparatus of claim 1, wherein the controller determines a discount rate correspondent to the total number by referring to the data table of the discount rates.

3. The apparatus of claim 2, wherein the storage further stores a price data table of unit prices respectively determined for the items and the controller calculates and displays a total rental fee based on the discount rate, the total number and the price data table.

4. The apparatus of claim 1, wherein the controller calculates and displays a combination of total numbers of items respectively for every combinations of contract data regarding all contracts correspondent to the new customer ID and effective on the application dates and the new data regarding the new applications.

5. The apparatus of claim 4, wherein the controller determines discount rates respectively for all the total numbers by referring the data table of discount rates.

6. The apparatus of claim 5, wherein the storage further stores a price data table of unit prices respectively determined for the items and the controller calculates and displays a combination of total rental fees based on the discount rates, the combination of the total numbers and the price data table.

7. A method for managing data of rental contracts with a plurality of customers, the method comprising:
storing a plurality of contract data in a storage, each contract datum including a customer ID identifying a customer, one or more item IDs identifying items, one or more numbers of items to be applied to rental contracts, a data table of discount rates, one or more dates of the rental contracts, and one or more terms of the rental contracts, the customer ID, the item IDs, the numbers, the dates, and the terms being interrelated in each rental contract;
receiving input of new data via an input device, the new data including a new customer ID, one or more new item IDs, one or more new numbers of items to be applied to new rental contracts, one or more application dates of the new rental contracts, one or more new terms of the new rental contracts;
reading out and summing up the numbers included in the contract data correspondent to the new customer ID and effective on the application date, from the storage;
calculating a total number of items by adding the new numbers of the new rental contracts to the numbers being summed-up; and
displaying the total number on a display.

8. The method of claim 7, further comprising:
determining a discount rate correspondent to the total number by referring to the data table of the discount rates.

9. The method of claim 8, further comprising:
storing a price data table of unit prices respectively determined for the items;
calculating a total rental fee based on the discount rate, the total number and the price data table; and
displaying the total rental fee on the display.

10. The method of claim 7, further comprising:
calculating a combination of total numbers of items respectively for every combinations of contract data regarding all contracts effective on the application dates and the new data regarding the new applications; and
displaying the combination of the total numbers of items on the display.

11. The method of claim 10, further comprising:
determining discount rates respectively for all the total numbers by referring the data table of discount rates.

12. The method of claim 11, further comprising:
storing a price data table of unit prices respectively determined for the items in the storage;
calculating a combination of total rental fees based on the discount rates, the combination of the total numbers and the price data table; and
displaying the combination of the total rental fees on the display.

13. A computer readable medium storing a program for operation of a computer, the computer readable medium comprising:
a storing routine storing a plurality of contract data in a storage, each contract datum including a customer ID identifying a customer, one or more item IDs identifying items, one or more numbers of items to be applied to rental contracts, a data table of discount rates, one or more dates of the rental contracts, and one or more terms of the rental contracts, the customer ID, the item IDs, the numbers, the dates, and the terms being interrelated in each rental contract;
an input routine receiving input of new data via an input device, the new data including a new customer ID, one or more new item IDs, one or more new numbers of items to be applied to new rental contracts, one or more application dates of the new rental contracts, one or more new terms of the new rental contracts;
a summing routine reading out and summing up the numbers included in the contract data correspondent to the new customer ID and effective on the application date, from the storage;
a calculation routine calculating a total number of items by adding the new numbers of the new rental contracts to the numbers being summed-up; and
a display routine displaying the total number on a display.
